(19) United States
(12) Patent Application Publication
(10) Pub. No.: US 2012/0119571 A1
(43) Pub. Date: May 17, 2012

(54) RECONFIGURABLE VEHICLE POWER AND SIGNAL DISTRIBUTION SYSTEM

(75) Inventors: Paul Moore, Blackwood South Wales (GB); James Humphries, Blackwood South Wales (GB)

(73) Assignee: GENERAL DYNAMICS UNITED KINGOOM LIMITED, London (GB)

(21) Appl. No.: 13/380,406

(22) PCT Filed: Jun. 22, 2010
(86) PCT No.: PCT/GB2010/051033

§ 371 Date: Feb. 7, 2012

(30) Foreign Application Priority Data
Jun. 23, 2009 (GB) 0910824.2

(51) Int. Cl. B60R 16/02; B60L 1/00

(52) U.S. Cl. 307/9.1

(57) ABSTRACT

A reconfigurable vehicle power and signal distribution system (10) is disclosed. The system comprises at least one conduit section (11) for housing a first and second power rail (22), and a communication line (20) for communicating signals along the conduit. The system further comprises a transfer hub (27) which enables the transfer of power and signals to a distribution hub that comprises a plurality of terminals for separately providing conditioned power to various system modules of the vehicle. The distribution of power from the distribution hub is dependent on signals received from a control unit via the communication line, which controls the power usage within the vehicle. The system enables the at least one conduit section, transfer hub and distribution hub to be reconfigured according to the topography of the vehicle.

### CROSS-REFERENCE TO RELATED APPLICATIONS

This application is a U.S. National-Stage entry under 35 U.S.C. §371 based on International Application No. PCT/GB2010/051033, filed Jun. 22, 2010 which was published under PCT Article 21 (2) and which claims priority to British Application No. 0910824.2, filed Jun. 23, 2009, which are all hereby incorporated in their entirety by reference.

### TECHNICAL FIELD

The technical field relates to a reconfigurable vehicle power and signal distribution system.

### BACKGROUND

Military fighting vehicles, such as tanks and personnel carriers of the wheeled and tracked variety, are equipped with various vehicle system modules to provide for example, power, communication, air conditioning and vehicle control. These modules are typically mounted internally and externally on the vehicle at distributed locations around the vehicle and are connected together via extensive wiring. As a result, it can be difficult to trace a failure of a particular module component, replace modules with up-dated or different modules and re-position modules within the vehicle. In addition, it is a difficult, time-consuming task to provide bespoke power and signals to modules having different functionality and which operate at different power ratings.

Existing wiring systems are often left exposed within a vehicle and as such, it is common for wires to become damaged or pulled from their respective connection as personnel and equipment move within the vehicle. Moreover, since the wiring systems are often unique for a particular vehicle and/or function, it is difficult to reconfigure a vehicle for a different function, such as to reconfigure a military patrol vehicle to operate and function as an ambulance.

In view of the foregoing, it is desirable to provide a reconfigurable vehicle power and signal distribution system which alleviates the above-mentioned problems. In addition, other desirable features and characteristics will become apparent from the subsequent summary and detailed description, and the appended claims, taken in conjunction with the accompanying drawings and this background.

### SUMMARY

In accordance with a first embodiment, there is provided a reconfigurable vehicle power and signal distribution system, the system comprising at least one conduit section for housing a first and second power rail, and a communication line for communicating signals along the at least one conduit section, the system further comprising a transfer hub which enables the transfer of power and signals to a distribution hub, the distribution hub comprising a plurality of outlets for separately providing conditioned power to various system modules of the vehicle, the distribution of power from the distribution hub being dependent on signals received from the communication line. The system permits a reconfiguration of the at least one conduit section, transfer hub and distribution hub according to the topography of the vehicle.

Preferably, the at least one conduit section and transfer hub are detachably connectable. In accordance with an embodiment, the one or more conduit sections are preferably further detachably connectable with each other, and may be of different length and/or shape to accommodate the contours of the vehicle. The system thus enables an implementation of different electronic architectures depending on vehicle requirements, through a reconfiguration of the at least one conduit section, transfer hub and the distribution hub.

The operational state of each of the plurality of outlets is dependent on signals received from the communication line. Preferably, the outlets are arranged to provide power at a selected voltage rating.

Preferably, the at least one conduit section comprises a cover which is detachably securable to a body of the respective conduit section to provide easy access to an interior of the conduit section.

The communication line of each conduit section preferably comprises a first connector disposed at a first end thereof and a second connector disposed at a second end thereof for connecting with adjacent conduit sections and/or a transfer hub of the system.

The transfer hub preferably comprises power transfer rails and a communication transfer line for connecting the power rails and communication line of a first conduit section to, power rails and a communication line respectively, of a second conduit section. Preferably, the transfer hub comprises a plurality of connectors for connecting to the power rails and communication line of the first and second conduit sections.

Preferably, the plurality of connectors comprise first and second connectors, such as male and female type connectors.

The at least one conduit section, transfer hub and distribution hub preferably comprise a body formed of a rigid material, such as a composite, a metal or a plastic. The body preferably provides a low electrical resistance path to a hull or chassis of the vehicle to provide an electrical earth for the system modules.

The transfer hub preferably further comprises a power terminal for transferring power to the system modules and/or the distribution hub. The transfer hub further comprises communication terminals for communicating signals between the communication line associated therewith to system modules and/or the distribution hub, and other devices connected to the transfer hub, such as video surveillance devices, computer device and communications equipment.

Preferably, the distribution hub comprises a power terminal for receiving power from the transfer hub, and a communication terminal for receiving signals from the transfer hub.

Preferably, the at least one conduit section houses a plurality of communication lines, each line being electromagnetically shielded by shielding means, which minimizes any interference on or between the communication lines. A shield also minimizes crosstalk between communication lines, the pickup of electromagnetic radiation from sources external to the conduit section and further minimizes the detection or interception of signals along the communication lines, by systems external to the system.

In accordance with an embodiment, the shield preferably comprises a plurality of channels extending along the conduit, each channel being arranged to receive one of the plurality of communication lines. Preferably, each channel comprises an opening along a longitudinal side thereof for receiving a communication line and which is arranged to be closed via a closure.

The power rails are preferably powered from a power source such as a power distribution unit, vehicle battery or generator. The power rails preferably comprise a first and second bar which are separately disposed in a channel which extends along the conduit. The channels are preferably arranged to electrically insulate the power rails from each other thereby preventing any electrical arcing between the power rails.

In an alternative embodiment, the power rails preferably comprise a first and second substantially planar rail which are substantially encapsulated in an electrical insulation material forming a laminate structure. In accordance with this alternative embodiment, the plurality of communication lines are preferably disposed upon a printed circuit board and comprise a plurality of so-called strip-line pairs. The strip-line pairs preferably separately extend along the printed circuit board within a channel defined between opposing ground plates and vertical interconnect access or VIA connections that serve to electrically shield the strip line pairs.

Preferably, the distribution hub comprises a conditioner and/or converter configured to condition and/or convert the power from said power rails and for delivering the power to one or more outlets provided on the distribution hub. The conditioning of power preferably comprises at least one of providing power at a different power rating at a plurality of outlets, switching the power to each outlet on and off, monitoring voltage and current levels, and the filtering of voltage and current signals.

Preferably, the distribution hub comprises a switch controlled via signals received from said communication line, the switch arranged to control the power supplied to said one or more outlets provided on the distribution hub.

In accordance with a second embodiment there is provided a vehicle power and signal distribution system, the system comprising a conduit for housing a first and second power rail, and a communication line for communicating signals along the conduit, the system further comprising a transfer hub which enables the transfer of power and signals to system modules of the vehicle. The conduit further comprises a shield for shielding said communication line to minimize interference on the line.

Preferably, the system permits a reconfiguration of the conduit and transfer hub according to the topography of the vehicle.

The system preferably further comprises a distribution hub for providing conditioned power to various system modules of the vehicle.

The conduit preferably comprises a plurality of conduit sections.

Further, preferred features of the second aspect may comprise one or more of the features of the first embodiment.

In accordance with a third embodiment, there is provided a reconfigurable vehicle power and signal distribution system, the system comprising a conduit for housing a first and second power rail, and a communication line for communicating signals along the conduit, the system further comprising a transfer hub which enables the transfer of power and signals to system modules of the vehicle. The system permits a reconfiguration of the conduit and transfer hub according to the topography of the vehicle.

The transfer hub further enables the transfer of power and signals to a distribution hub, the distribution hub comprising a plurality of outlets for separately providing conditioned power to various system modules of the vehicle. Preferably, the distribution of power from the distribution hub is dependent on signals received from the communication line.

The conduit preferably comprises a plurality of conduit sections.

Further preferred features of the third embodiment may comprise one or more of the features of the first and/or second embodiment.

In accordance with a fourth embodiment there is provided a vehicle comprising a vehicle power and signal distribution system according to the first, second or third embodiment and a control unit for controlling the operation of the system.

Preferably, the vehicle comprises a military vehicle, such as an armored fighting vehicle or armored personnel carrier.

Further preferred features of the fourth embodiment may comprise one or more of the preferred features of the first, second, and/or third embodiment.

### BRIEF DESCRIPTION OF THE DRAWINGS

Embodiments will now be described by way of an example only and with reference to the accompanying drawings, in which:

FIG. 1 is a schematic illustration of a vehicle power and signal distribution system in accordance with a first embodiment;

FIG. 2 is a cross-sectional view through a conduit of the system of FIG. 1;

FIG. 3 is an exploded view of a conduit section according to a second embodiment;

FIG. 4 is a magnified view of the connectors disposed at one end of the conduit section illustrated in FIG. 3; and

FIG. 5 is a sectional view across a transfer hub for connecting conduit sections according to the second embodiment.

### DETAILED DESCRIPTION

The following detailed description is merely exemplary in nature and is not intended to limit the application and uses. Furthermore, there is no intention to be bound by any theory presented in the preceding background or summary or the following detailed description.

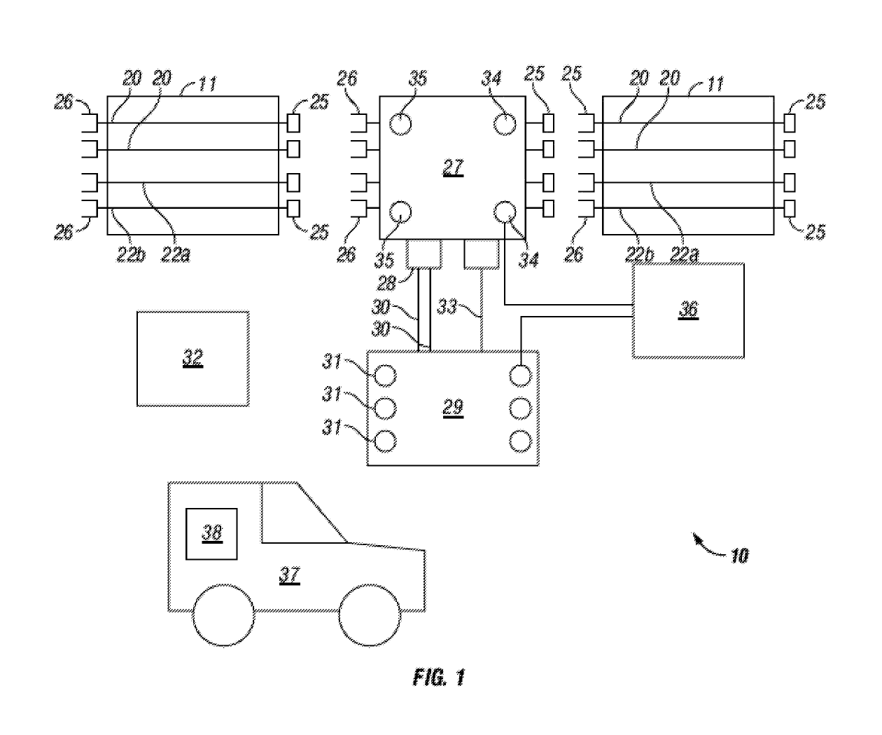

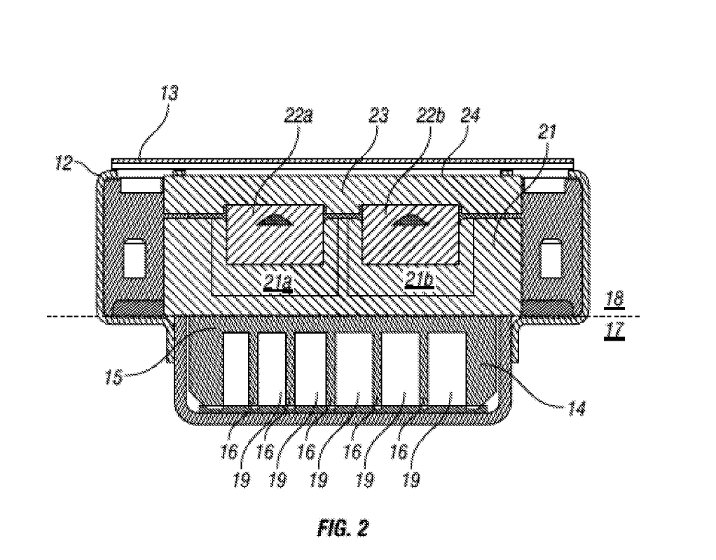

Referring to FIG. 1 and FIG. 2 of the drawings, there is illustrated a vehicle power and signal distribution system 10 according to an embodiment for a military vehicle, such as a tank or armored personnel carrier (not shown). The system 10 comprises a conduit divided into a plurality of conduit sections 11 which are substantially rectangular in cross-section and which are formed of a metal, such as aluminum, steel or a rigid electromagnetic compatible plastic material, which are intended to protect the component members of the conduit and provide an electrical earth to a vehicle hull or chassis (not shown). Each conduit section 11 comprises a housing 12 having a channel formed therein which is open at a front side, and which is closed by a detachable cover 13 which extends longitudinally of the conduit section 11. The cover 13 is detachably coupled to the respective housing 12 via a plurality of fasteners (not shown), such as a plurality of clips (not shown), which enable the cover 13 to be readily coupled and uncoupled from the housing 12. The conduit sections 11 may be linear in shape or angular for example, to match the interior contours of a vehicle 37.

According to a first embodiment, the conduit sections 11 comprise an insert 14, which is substantially comb-like in cross-section and which is formed of a metal, such as aluminum. The insert 14 comprises a base 15 which is arranged to extend along the length of the conduit section 11 and a plurality of fingers 16 which extend from the base 15. When the insert 14 is placed within the conduit section 11 with the fingers 16 extending away from the open front wall of the conduit body section 12, the base 15 of the insert 14 divides the interior of the conduit section 11 into first and second longitudinally extending regions 17, 18.

The first region 17 comprises the plurality of fingers 16 which extend from the base 15 substantially parallel to each other and which define a plurality of channels 19 therebetween, which extend along the conduit section 11. Each channel 19 is arranged to separately receive a communications line 20, such as a communication wire or optical fiber, for communicating signals along the conduit section. In this manner, each communication line 20 is surrounded by the channel fingers 16, base 15 and conduit body section 12. It will be appreciated that each communication line 20 comprises a metallic or otherwise electromagnetic shield surround and as such, each channel 19 becomes electromagnetically isolated from other channels 19 and the surrounding environment, which thus serves to minimize electromagnetic interference in the respective communication lines 20.

The second section 18 comprises a carrier 21 of insulating plastics material, such as nylon, which is substantially W-shaped in cross-section, and which comprises a first and second receptacle 21a, 21b. Each conduit section 11 comprises several carriers 21 disposed along the length of the conduit section 11 and are mounted upon the base 15 of the insert 14. The receptacles 21a, 21b of the carriers 21 are arranged to separately receive a positive and negative power rail 22a, 22b, and are closed by a plastic, for example nylon, lid 23 which is arranged to extend over the power rails 22a, 22b. The carriers 21 and lids 23 serve to insulate the power rails 22 from the insert 14 and the body 12 of the conduit section 11 and suitably support the power rails 22 within the conduit section 11. The lid 23 is spaced from the interior of the conduit cover 13 by a layer 24 of electromagnetic compatible material which further helps to minimize any transmission of electromagnetic radiation into and from the conduit section 11.

The power rails 22 are formed of copper and are substantially rectangular in cross-section. The cross-sectional area is substantial and is sized so that the power rails 22 can withstand currents greater than 1000 A without failure or breakdown. Opposite longitudinal ends of each power rail 22 and communication line 20 comprise a first and second connector respectively, such as a male and female connector 25, 26, which permit the power rails 22 and communication lines 20 to be readily connected with power rails 22 and communication lines 20 of further conduit sections 11.

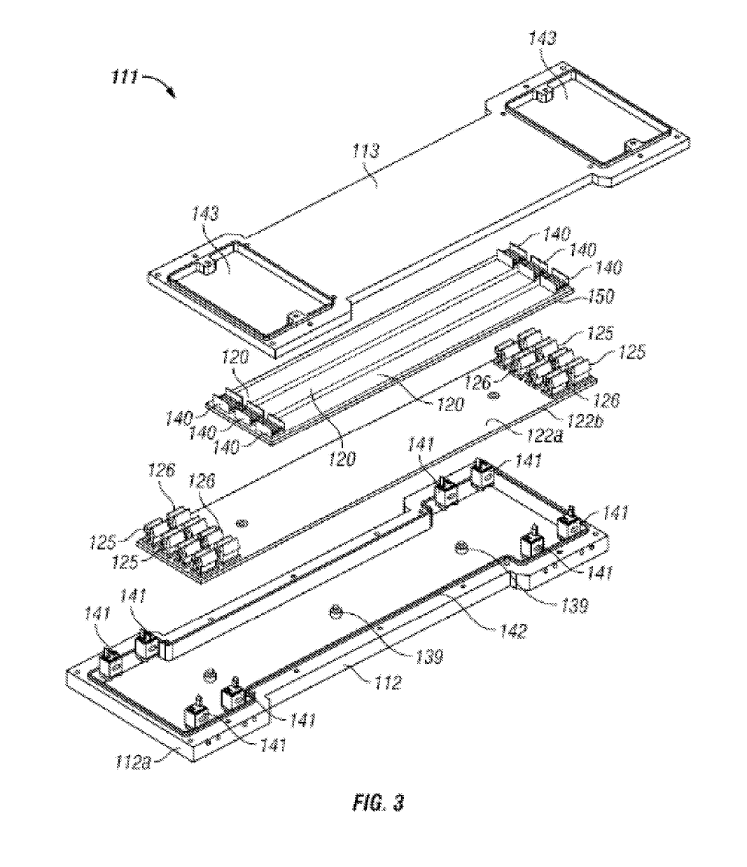

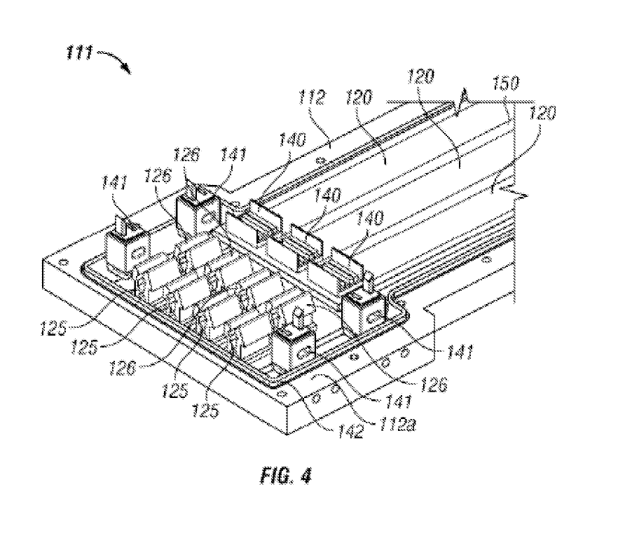

Referring to FIG. 3 and FIG. 4 of the drawings, there is illustrated a conduit section 111 according to a second embodiment. The conduit section 111 of the second embodiment is similar to the conduit section 11 of the first embodiment and so like features have been referenced using the same numerals but increased by 100.

The conduit section 111 illustrated in FIG. 3 of the drawings comprises a housing 112 having a peripherally extending wall 112a which defines a channel therebetween. The conduit section 111 is open at a front side and is closed by a detachable cover 113 which extends longitudinally of the conduit section 111. The cover 113 is detachably coupled to the respective body 112 via a plurality of fasteners (not shown), such as a plurality of clips (not shown), which enable the cover 113 to be readily coupled and uncoupled from the conduit body 112. The conduit sections 111 may be linear in shape or angular for example, to match the interior contours of a vehicle 37.

The conduit section 111 comprises a plurality of coupling points 139 disposed along the length of the channel, for securing the power rails 122a, 122b and communication lines 120 within the channel to thus minimize damage induced by sudden impacts upon the conduit section 111 and/or vehicle vibration. The power rails 122a, 122b of the conduit section 111 comprise a first and second substantially planar rail which are encapsulated with an electrical insulation material (not shown) to form a laminate structure. The insulation material is arranged to withstand electrical and thermal breakdown associated with currents up to approximately 1000 A on the power rails 122a, 122b for example and further protect the planar rails 122a, 122b from environmental corrosion.

The planar rails 122a, 122b extend to each distal end of the housing 112 within the channel and separately terminate at a plurality of electrical connectors 125, 126. The electrical connectors 125, 126 are disposed in rows at each longitudinal end of the body section 112, and are disposed substantially upstanding on the respective planar rail 122a, 122b. The first planar rail 122a which may comprise an electrically positive polarity for example, is arranged to extend to the outermost row of connectors 125 at each longitudinal end of the body section to provide for a series of positive electrical power connectors 125. In contrast, the second planar rail 122b which may comprise an electrically negative polarity for example, is arranged to extend to the innermost row of connectors 126 at each longitudinal end of the body 112 to provide for a series of negative electrical power connectors 126.

The electrical communication lines 120 of the conduit section 111 are realized upon a substantially planar printed circuit board 139 which is arranged to extend over the laminate structure of power rails 122a, 122b within the housing 112. The printed circuit board 139 comprises a laminate structure of plurality of ground plates (not shown) interspersed with a layer of electrically insulating material (not shown). The printed circuit board 139 further comprises a plurality of vertical interconnect access or VIA connections (not shown) which extend between the ground plates (not shown), along the length thereof, such that the ground plates and VIA connections define a plurality of electrically shielded channels to minimize crosstalk between communication lines 120, etc. The printed circuit board 139 further comprises a plurality of connectors 140 disposed at each longitudinal end thereof to provide for the coupling of the communication lines 120 to communications lines 120 of other conduit sections 111.

In addition to the printed circuit board 139, the conduit section 111 may comprise a flexible cable harness (not shown) for retaining a plurality of optical communication lines (not shown) and/or electrical communication lines (not shown). Referring to FIG. 4 of the drawings, the optical communication lines (not shown) may comprise a plurality of optical fibers (not shown), for example, which are terminated at each longitudinal end of the conduit section 111 by a series of optical connectors 141.

The laminate arrangement of power rails 122a, 122b and the communication lines 121, namely those associated with the printed circuit board 140 and the flexible wire harness (not shown) are held separated from each other within the conduit section 111 by an insulating material (not shown) which serves to minimize the transfer of thermal energy between the power rails 122a, 122b and the communication lines 121. The conduit section 111 further comprises a layer of electromagnetic absorbent material (not shown) which further helps minimize any transmission of electromagnetic radiation between the power rails 122a, 122b and the communication lines 121.

The cover 113 is sized and shaped to substantially cover the channel formed within the housing and comprises a peripherally extending channel (not shown) formed on the underside thereof, which is arranged to receive a peripherally extending projection 142 disposed on an upper edge of the wall 112a of the housing 112. The cooperation of the channel (not shown) on the cover 113 and the projection 142 serves to minimize any electromagnetic radiation from passing between the cover 113 and the upper edge of the wall 112a of the housing 112 and thus serves to electromagnetically seal the conduit section 111 from the outside environment. The cover 113 further comprises an aperture 143 disposed at each longitudinal end thereof to enable access and thus connection to the connectors 125, 126 on the planar rails 122a, 122b, the electrical connectors on the printed circuit board 140 and the optical connectors 141 of the optical fibers (not shown).

The conduit sections 11, 111 of the first and second embodiment are interspersed with a plurality of transfer hubs 27. Each transfer hub 27 is arranged to channel power and communication signals from the power rails 22, 122 and communication lines 20, 120 of the conduit sections 11, 111 respectively, to other conduit sections 11, 111 and various vehicle system modules 36, such as a radio communications module associated with the vehicle 37. Power is supplied to the power rails 22, 122 from a battery supply 38 within the vehicle 37. The power is delivered to the various transfer hubs 27 through the power rails 22, 122 as a 28V dc supply; however, it will be appreciated that other ac or dc voltages may also be used. Since this 28V dc supply may not be an optimal rating for the various modules 36, the power from each transfer hub 27 may be passed via a power terminal 28 to a distribution hub 29 via a power connection cable 30.

The distribution hub 29 comprises a plurality of outlets 31, and is arranged to condition the power supply to each outlet 31 so that separate outlets 31 provide an alternative voltage supply, for example, 5V, 12V, 24V etc. The conditioning however, may alternatively or additionally comprise filtering of the voltage and current on the power rails and/or monitoring the voltage and/or current levels. It is also envisaged that the conditioning may further comprise the provision of a fuse or switch to selectively isolate power from selected outlets.

The distribution hub 29 is further arranged to receive signals from a control unit 32 via one or more of the communication lines 20, 120 via a control area network or CAN bus 33, for example: the CAN bus 33 is one of the communication lines that is used in controlling the operational state of each outlet 31. In this manner, it is possible to control the on/off state of each outlet 31 to control the power distribution within the system 10. The transfer hub 27 may comprise further connections, such as an Ethernet connection 34 or a video connection 35 for example.

The control signals are passed along the communication lines 20, 120 from the control unit 32 which may be operated by vehicle personnel (not shown). The control unit 32 permits various modules 36 to be switched on or off, as required in order to conserve power, for example or operate in a particular mode, such as a quiet or stealth mode.

The system of conduit sections 11, 111 and transfer hubs 27 permit a reconfigurable arrangement of power and data distribution within a vehicle 37 to suit a particular vehicle function or vehicle interior. In use, the conduit sections 11, 111 are mounted within a vehicle 37 and connected together using the transfer hubs 27. Various conduit sections 11, 111 having a variety of sizes and configurations may be employed so that the conduit extends around the desired contour of the interior of the vehicle 37. The conduit sections 11, 111 are connected in series with one or more transfer hubs 27 via the connectors 25, 125, 26, 126 disposed thereon to form a loop or ring configuration. It is envisaged that such a configuration will provide a level of redundancy since the ring will provide for two paths of connectivity to the required module.

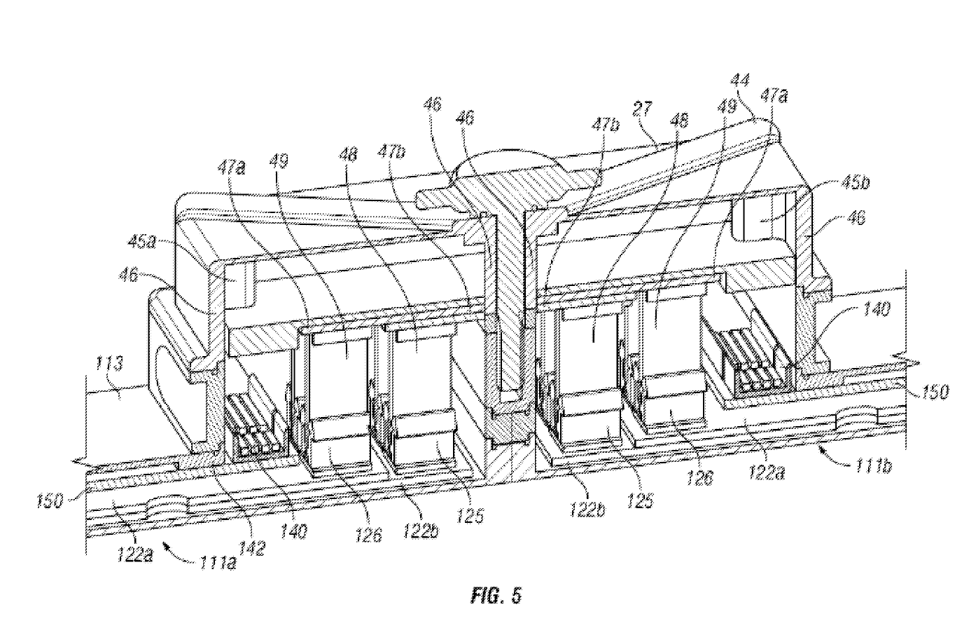

Referring to FIG. 5 of the drawings, there is illustrated a sectional view across a transfer hub 27 which is used to bridge the connectors 125, 126, 140, 141 disposed at one end of one conduit section 111a according to the second embodiment, with the connectors disposed at the other end of a second conduit section 111b, also according to the second embodiment.

The transfer hub 27 comprises a body 44 which is arranged to couple with the first and second conduit sections 111a, 111b and provide an electromagnetic seal with the respective conduit sections 111a, 111b. The body 44 of the transfer hub 27 as illustrated in FIG. 5 of the drawings, comprises a first and second chamber 45a, 45b having respective side walls 46, which are separately arranged to couple around the aperture 143 disposed at one end of the first conduit section 111a and the aperture 143 disposed at the other end of the second conduit section 111b. This coupling may be achieved using fasteners such as clips or nuts and bolts (not shown) for example and serves to electromagnetically seal the interior of the system from the surrounding environment. The transfer hub 27 further comprises power transfer rails 47a, 47b and communication transfer lines (not shown), similar to the conduit sections 111 but of a reduced length, which extend between the chambers 45a, 45b of the transfer hub 27. The transfer hub 27 further comprises connectors 48, 49 disposed within the chambers 45a, 45b which extend from the power transfer rails 47a, 47b and the communication transfer lines (not shown) respectively, and which are adapted to connect with the respective connectors 125, 126, 140, 141 disposed at the longitudinal ends of the respective conduit sections 111a, 111b to enable the transfer of power and communication signals from one conduit section 111a to the other 111b.

The transfer hubs 27 serve to provide power and data break out points along the conduit, so that external devices can take power from the power rails 22a, 122a, 22b, 122b and so that signals to and/or from the vehicle modules (not shown) can be carried along the communication lines 20, 120.

The power is supplied to the power rails 22a, 122a, 22b, 122b of the system 10 from a power distribution unit, such as a vehicle battery 38 or generator, and may be distributed from each transfer hub 27 via a distribution hub 29, which is connected to the respective transfer hub 27 via the power connection cable 30 and CAN line 33. The system modules 36 can then be connected with the appropriate outlet 31 on the distribution hub 29 and to the transfer hub 27 using the appropriate communication terminal 34.

Once the system has been installed within the vehicle 37, vehicle personnel (not shown) can then control the various outlets 31 on the distribution hub 29 by sending signals from the control unit 32 to the respective transfer hub 27 and distribution hub 29 via the communication lines 20 and CAN line 33. If required, the power supply to selected distribution hubs 29 and/or selected outlets 31 on a particular distribution hub 29 can then be switched off to conserve power for example or to conform with a particular mode of vehicle operation, such as quiet mode. If necessary, the conduit sections 11 may be uncoupled from each other and/or the transfer hubs 27 and re-routed within the vehicle 37 to accommodate the addition or removal of system modules 36, for example.

It is envisaged that the vehicle power and signal distribution system may further support the distribution of conditioned air within the vehicle 37 to provide for a comfortable environment for the occupants (not shown) and for controlling the temperature of the components of the system. In this respect, it is envisaged that the conduit sections 111 and transfer hubs 27 will provide a suitable duct for the transfer of conditioned air around the vehicle 37. It is further envisaged that the conduit sections 111 may provide a suitable support for lighting within the vehicle 37, for example.

From the foregoing therefore, it is evident that the system provides a simple yet versatile means of reconfiguring the distribution of control, power and communication signals around a vehicle. Moreover, while at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope as set forth in the appended claims and their legal equivalents.

1. A reconfigurable vehicle power and signal distribution system for a vehicle, the system comprising:
a conduit having at least one conduit section for housing a first power rail and a second power rail, and a communication line for communicating signals along the at least one conduit section;
a distribution hub comprising a plurality of outlets for separately providing conditioned power to various system modules of the vehicle, a distribution of power from the distribution hub at least partially dependent on the signals received from the communication line; and
a transfer hub which enables the transfer of power and the signals to the distribution hub,
wherein the system permits a reconfiguration of the at least one conduit section, the transfer hub and the distribution hub according to a topography of the vehicle.

2. The system according to claim 1, wherein the at least one conduit section and transfer hub are detachably connectable.

3. The system according to claim 1, wherein the conduit comprises one or more conduit sections which are detachably connectable with each other.

4. The system according to claim 1, wherein the at least one conduit section comprises a cover which is detachably securable to a body of the at least one conduit section to provide access to an interior of the the at least one conduit section.

5. The system according to any claim 1, wherein an operational state of each of the plurality of outlets is dependent on the signals received from the communication line.

6. The system according to claim 1, wherein the distribution hub comprises a conditioner configured to condition the power from said first power rail and said second power rail and for delivering the power to one or more of the plurality of outlets provided on the distribution hub.

7. The system according to claim 1, wherein the plurality of outlets are arranged to provide the power at a selected voltage rating.

8. (canceled)

9. The system according to claim 1, wherein the transfer hub comprises a plurality of power transfer rails and a communication transfer line for connecting the first power rail and the second power rail and a first communication line of a first conduit section to power rails and a second communication line, respectively, of a second conduit section.

10. (canceled)

11. (canceled)

12. (canceled)

13. (canceled)

14. The system according to claim 1, wherein the transfer hub further comprises communication terminals for communicating the signals from the communication line associated therewith to the system modules and the distribution hub.

15. (canceled)

16. The system according to claim 1, wherein the conduit is configured to house a plurality of communication lines, each of the plurality of communication lines electromagnetically shielded by a shield, which minimizes interference.

17. The system according to claim 16, wherein the shield comprises a plurality of channels disposed within the conduit, with each of the plurality of channels arranged to receive one of the plurality of communication lines.

18. (canceled)

19. The system according to claim 1, wherein the distribution hub comprises a switch controlled via a said communication line, the switch arranged to control the power supplied to said plurality of outlets provided on the distribution hub.

20. (canceled)

21. The system according to claim 1, wherein the first power rail and the second power rail comprise a first bar disposed in a first channel and a second bar separately disposed from the first bar in a second channel which extends along the at least one conduit section.

22. The system according to claim 21, wherein the first channel and the second are arranged to electrically insulate the first power rail and the second power rails from each other.

23. The system according to claim 1, wherein the first power rail and the second power rail comprise a first substantially planar rail and a second substantially planar rail which are substantially encapsulated in an electrical insulation material forming a laminate structure.

24. A vehicle power and signal distribution system for a vehicle, the system comprising:
a conduit for housing a first power rail and a second power rail;
a communication line for communicating signals along the conduit;
a transfer hub which enables the transfer of power and the signals to system modules of the vehicle, and
a shield for shielding said communication line to minimize interference on the communication line.

25. The system according to claim 24, wherein the system further comprises a reconfigurable system permitting a reconfiguration of the conduit and transfer hub according to a topography of the vehicle.

26. (canceled)

27. (canceled)

28. A reconfigurable vehicle power and signal distribution system for a vehicle, the system comprising:
a conduit for housing a first power rail and a second power rail;
a communication line for communicating signals along the conduit;
a transfer hub which enables the transfer of power and the signals to system modules of the vehicle,
wherein the system permits a reconfiguration of the conduit and transfer hub according to a topography of the vehicle.

29. The system according to claim 28, wherein the transfer hub further enables the transfer of the power and the signals to a distribution hub, the distribution hub comprising a plurality of outlets for separately providing conditioned power to system modules of the vehicle.

30. (canceled)

31. (canceled)

32. (canceled)

33. The system according to claim 28, wherein the vehicle comprises a military vehicle.
